(19) United States
(12) Patent Application Publication
(10) Pub. No.: US 2018/0136879 A1
(43) Pub. Date: May 17, 2018

(54) INTERMIDIATE CIRCUIT FOR MEMORY CARD ACCESS

(71) Applicant: REALTEK SEMICONDUCTOR CORPORATION, Hsinchu (TW)

(72) Inventors: NENG-HSIEN LIN, KAOHSIUNG CITY (TW); JIUNN-HUNG SHIAU, TAIPEI CITY (TW)

(21) Appl. No.: 15/671,568

(22) Filed: Aug. 8, 2017

(30) Foreign Application Priority Data
Nov. 14, 2016 (TW) 105136994

(51) Int. Cl. G06F 3/06

(52) U.S. Cl. CPC G06F 3/0659; G06F 3/0673; G06F 3/0604

(57) ABSTRACT

The present invention discloses an intermediate circuit including: a detection circuit detecting a memory card signal to generate a detection result indicating the memory card signal conforming to one of a first and a second signal types which are dedicated to different physical transmission interfaces respectively; a control circuit generating a conversion control signal and a selection control signal according to the detection result; a conversion circuit converting the memory card signal into a card-to-system conversion signal of the second signal type according to the conversion control signal when the memory card signal conforms to the first signal type; and a selection circuit outputting the card-to-system conversion signal according to the selection control signal when the memory card signal conforms to the first signal type, and outputting the memory card signal according to the selection control signal when the memory card signal conforms to the second signal type.

### BACKGROUND OF THE INVENTION

### 1. Field of the Invention

The present invention relates to memory card access, especially to an intermediate circuit for memory card access.

### 2. Description of Related Art

Generally speaking, a memory card access operation is carried out by an independent card reader chip, or by a system on chip (SoC) or a chipset capable of memory card access. Since the current trend of an electronic device is towards multi-function integration and miniaturization, an SoC/chipset capable of memory card access is growing popular, and its way to access a memory card is shown in FIG. 1. As shown in FIG. 1, an SoC/Chipset 110 is usually connected to a memory card socket 130 through a parallel interface 120, and thereby accesses a memory card in the memory card socket 130.

However, an SoC/chipset is usually set at or near the center of a circuit board, and thus the distance between the SoC/chipset and a memory card is quite long. As the distance increases, it's more and more difficult to implement the layout of a parallel interface between the SoC/chipset and the memory card. For one thing, the position of an output pin reserved by the SoC/chipset for memory card access is not the first priority to the SoC/chipset and usually not optimal, which raises the difficulty over the parallel interface layout; for another, the design of a high speed parallel interface is very strict with the signal timing of each transmission path while the lengths of these transmission paths are hard to be the same in practice, which makes the synchronization of the signal timings of these transmission paths hard to be realized or maintained. In addition, a lengthy and speedy parallel interface without a proper layout may cause a serious problem of electromagnetic interference (EMI).

In order to solve the aforementioned problems, some memory card access protocol (e.g., Ultra High Speed-II (UHS-II) transmission protocol of Secure Digital (SD) card) adopts a serial interface (i.e., Serializer/Deserializer (SerDes) interface). Since a SerDes signal is characterized by being robust to interference and having weak EMI effect, the SerDes interface can replace a parallel interface for the extension of transmission distance without brining serious side effects, and thereby relieve the difficulty of layout implementation, reduce the influence of EMI, and solve the problems in parallel transmission. However, in order to be compatible with a conventional memory card, a card reader interface which supports UHS-II protocol still keeps a parallel interface for such a conventional memory card; as a result, the problems in parallel transmission still remains.

### SUMMARY OF THE INVENTION

An object of the present invention is to provide an intermediate circuit capable of ensuring compatibility and making an improvement over the prior arts encountering the problems in long distance parallel transmission.

The present invention discloses an intermediate circuit for memory card access. An embodiment of the intermediate circuit is applicable to a card-to-system operation, and comprises a detection circuit, a control circuit, a conversion circuit and a selection circuit. The detection circuit detects a memory card signal to generate a detection result indicating the memory card signal conforming to one of a plurality of signal types, in which the plurality of signal types includes a first signal type and a second signal type that are dedicated to different physical transmission interfaces respectively. The control circuit generates a conversion control signal and a selection control signal according to the detection result. The conversion circuit converts the memory card signal into a card-to-system conversion signal of the second signal type according to the conversion control signal when the detection result indicates that the memory card signal conforms to the first signal type. The selection circuit receives the card-to-system conversion signal and outputs the card-to-system conversion signal as a system-side output signal according to the selection control signal when the detection result indicates that the memory card signal conforms to the first signal type; and the selection circuit receives the memory card signal and outputs the memory card signal as the system-side output signal according to the selection control signal when the detection result indicates that the memory card signal conforms to the second signal type.

Another embodiment of the intermediate circuit is applicable to a system-to-card operation, and comprises a detection circuit, a control circuit, a conversion circuit and a selection circuit. The detection circuit detects a memory card signal to generate a detection result indicating the memory card signal conforming to one of a plurality of signal types, in which the plurality of signal types includes a first signal type and a second signal type that are dedicated to different physical transmission interfaces respectively. The control circuit generates a conversion control signal and a selection control signal according to the detection result. The conversion circuit converts a system-side signal into a system-to-card conversion signal as a card-side output signal according to the conversion control signal when the detection result indicates that the memory card signal conforms to the first signal type. The selection circuit receives the system-side signal and outputs the system-side signal to the conversion circuit for generating the system-to-card conversion signal as the card-side output signal according to the selection control signal when the detection result indicates that the memory card signal conforms to the first signal type; and the selection circuit receives the system-side signal and outputs the system-side signal as the card-side output signal according to the selection control signal when the detection result indicates that the memory card signal conforms to the second signal type.

A further embodiment of the intermediate circuit is applicable to both a card-to-system operation and a system-to-card operation. The embodiment comprises a conversion circuit. The conversion circuit is configured to convert a memory card signal into a card-to-system conversion signal and output the card-to-system conversion signal to a system, and configured to convert a system-side signal into a system-to-card conversion signal and output the system-to-card conversion signal to a memory card, wherein the memory card signal conforms to one of a plurality of signal types, the plurality of signal types includes a first signal type and a second signal type that are dedicated to different physical transmission interfaces respectively, and the system-side signal conforms to the second signal type.

These and other objectives of the present invention will no doubt become obvious to those of ordinary skill in the art after reading the following detailed description of the exemplary embodiments that are illustrated in the various figures and drawings.

### BRIEF DESCRIPTION OF THE DRAWINGS

FIG. 1 illustrates a memory card access operation of a prior art.

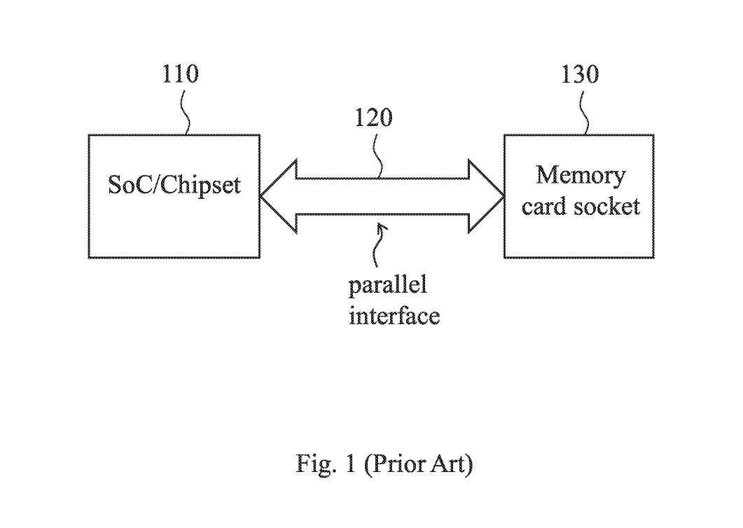

FIG. 2a illustrates an embodiment of the intermediate circuit of the present invention.

FIG. 2b illustrates the intermediate circuit of FIG. 2a for a card-to-system operation.

FIG. 2c illustrates the intermediate circuit of FIG. 2a for a system-to-card operation.

FIG. 3 illustrates an embodiment of the conversion circuit of FIG. 2a.

FIG. 4 illustrates another embodiment of the intermediate circuit of the present invention.

### DETAILED DESCRIPTION OF THE PREFERRED EMBODIMENTS

The present invention discloses an intermediate circuit for memory card access. This intermediate circuit is capable of effectively extending the transmission distance of a memory card signal/a system-side memory card signal (hereafter, system-side signal), and ensuring the compatibility of memory card access. The said memory card signal/system-side signal includes data that are read from/to be written into a memory card, and/or includes instruction(s) for controlling/informing the memory card/a system; and such signal definition/characteristic is well known in this industrial field.

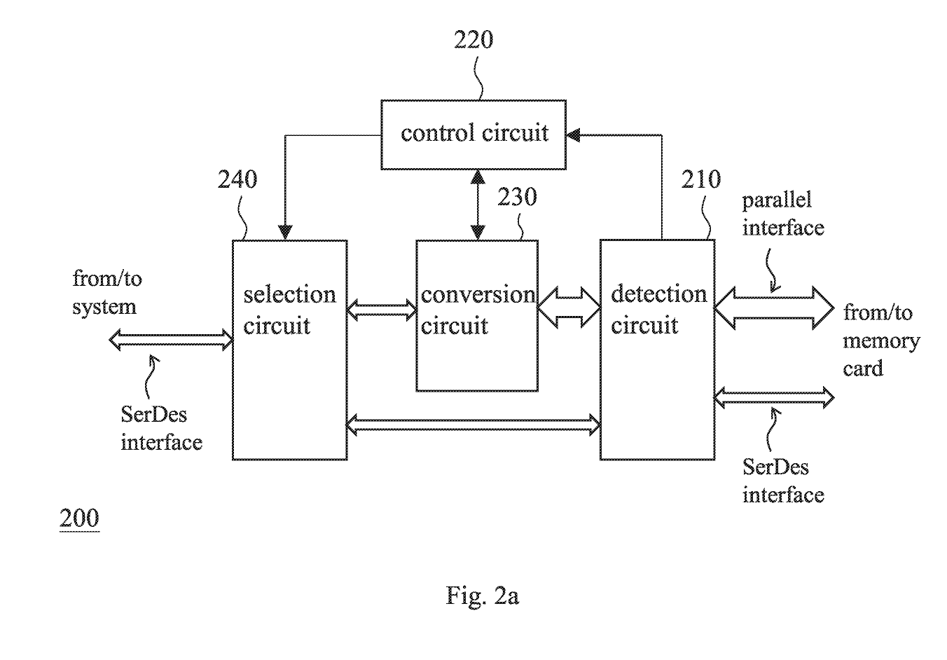

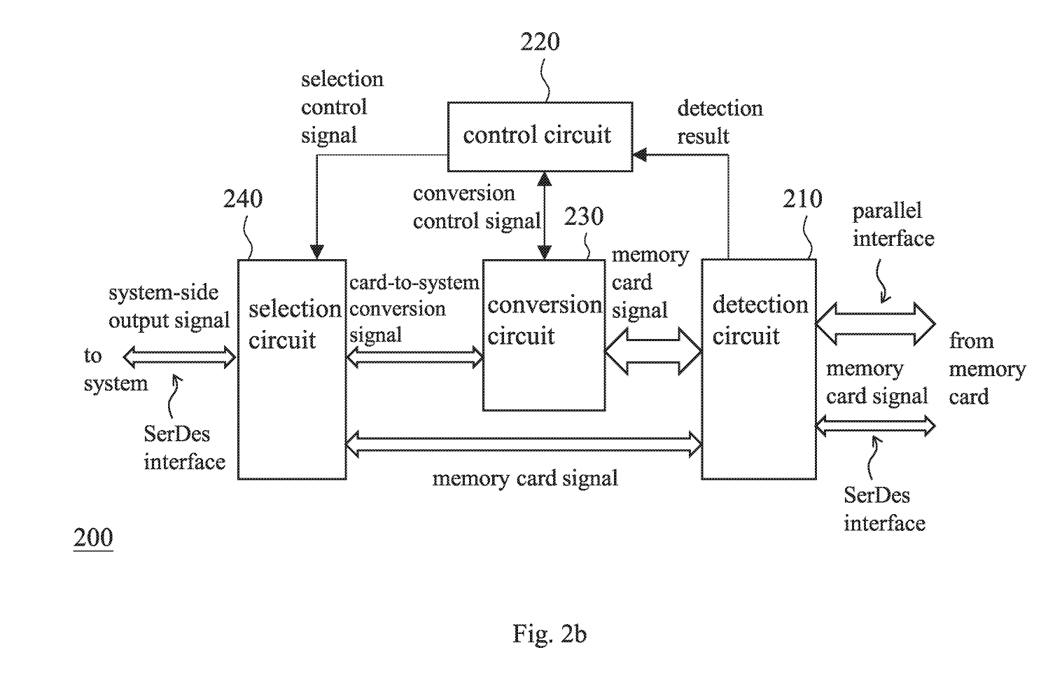

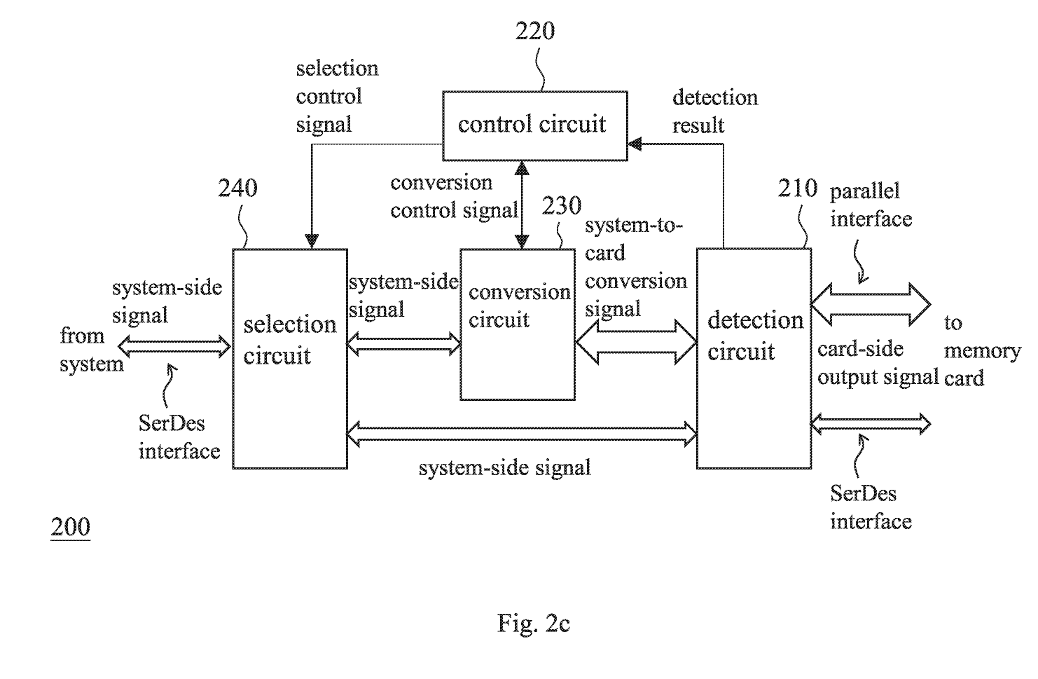

Please refer to FIG. 2a. FIG. 2a shows an embodiment of the intermediate circuit of the present invention. The intermediate circuit 200 of FIG. 2a includes a detection circuit 210, a control circuit 220, a conversion circuit 230 and a selection circuit 240. The intermediate circuit 200 is applicable to a card-to-system operation (i.e., signal transmission from a memory card to a system (a.k.a. host)) and a system-to-card operation (i.e., signal transmission from a system to a memory card). The physical transmission interface between a memory card and the intermediate circuit 200 includes a plurality of transmission interfaces. An embodiment of the plurality of transmission interfaces includes a parallel interface and a SerDes (Serializer/Deserializer) interface; of course people of ordinary skill in the art can use other kinds of interfaces as the plurality of transmission interfaces in accordance with their demand and the disclosure of the present invention. The physical transmission interface between a system and the intermediate circuit 200 includes a specific interface. An embodiment of this specific interface is a SerDes interface; of course those of ordinary skill in the art can use another kind of interface as the specific interface. A preferred type of the specific interface is one of the types of the aforementioned transmission interfaces between the memory card and the intermediate circuit 200, so that when accessing the memory card that is accessible by particular one of the transmission interfaces (e.g., SerDes interface), the signal of the memory card can be transmitted to the system through the particular transmission interface (e.g., SerDes interface) and the specific interface (e.g., SerDes interface) without conversion.

The following description explains how the intermediate circuit 200 works for a card-to-system operation.

Please refer to FIG. 2b. The detection circuit 210 detects a memory card signal (which is from the aforementioned memory card) and thereby generates a detection result. The detection result indicates that the memory card signal conforms to one of a plurality of signal types. These signal types are defined by different transmission protocols (e.g., a parallel transmission protocol and a serial transmission protocol), so that the detection circuit 210 is operable to carry out detection according to the transmission protocols. For instance, the detection circuit 210 can find out whether the pattern of the memory card signal conforms to any signal pattern defined by the transmission protocols, and accordingly generate the detection result. In this embodiment, the signal types include a first signal type and a second signal type which are dedicated to a parallel interface and a SerDes interface respectively. After the detection result is generated, the control circuit 220 generates a conversion control signal and a selection control signal according to the detection result. In detail, when the detection result indicates that the memory card signal conforms to the aforementioned first signal type, the conversion control signal of the control circuit 220 instructs the conversion circuit 230 to execute a conversion operation while the selection control signal instructs the selection circuit 240 to output a conversion signal; when the detection result indicates that the memory card signal conforms to the aforementioned second signal type, the selection control signal instructs the selection circuit 240 to output the memory card signal while the conversion operation does not matter, which implies that the selection circuit 240 won't output the signal from the conversion circuit regardless of whether the conversion operation is executed by the conversion circuit 230. When the detection result indicates that the memory card signal conforms to the first signal type, the conversion circuit 230 converts the memory card signal into a card-to-system conversion signal conforming to the second signal type according to the conversion control signal; more specifically, since the first signal type and the second signal type are defined by different transmission protocols (e.g., a parallel transmission protocol and a serial transmission protocol), the conversion circuit 230 has to turn the memory card signal conforming to the first signal type into the card-to-system conversion signal conforming to the second signal type according to the signal specifications of those transmission protocols. Afterwards, provided that the memory card signal conforms to the first signal type, the selection circuit 240 receives the card-to-system conversion signal, and outputs the card-to-system conversion signal as a system-side output signal, that is outputted to the aforementioned system, according to the selection control signal; provided that the memory card signal conforms to the second signal type, the selection circuit 240 receives the memory card signal, and outputs the memory card signal as the system-side output signal according to the selection control signal.

It should be noted that from the system's point of view, the intermediate circuit 200 acts as a memory card; form the memory card's point of view, the intermediate circuit 200 acts as a system. In other words, thanks to the intermediate circuit 200, both the system and the memory card have no need to be altered; however, this is not a limitation to the scope of the present invention. In addition, the initialization and negotiation procedures between the intermediate circuit 200 and the system are similar to those normal procedures between a memory card and a system; the initialization and negotiation procedures between the intermediate circuit 200 and the memory card are similar to those normal procedures between a system and a memory card. Since the said initialization and negotiation procedures are well known in this industrial field, the detail is omitted.

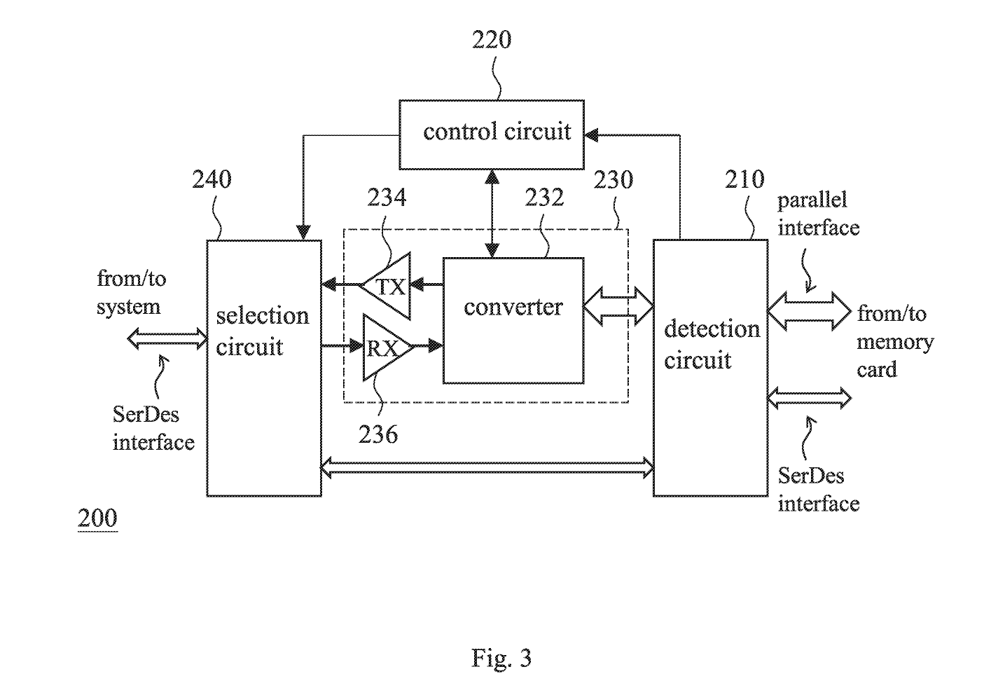

On the basis of the above, when the physical transmission interface between the aforementioned memory card and the intermediate circuit 200 is different from the physical transmission interface between the system and the intermediate circuit 200, the conversion circuit 230 has to carry out the conversion operation; meanwhile, the conversion circuit 230 needs to communicate with the system through an proper communication manner. More specifically, a system-side signal (from the system) needs to be received in light of its signal specification and thereby converted by the conversion circuit 230, while the aforementioned card-to-system conversion signal needs to be transmitted to the system in light of its signal specification; therefore, as shown in FIG. 3, an embodiment of the conversion circuit 230 includes a converter 232, a transmitter (labeled with “TX” in the drawings) 234 and a receiver (labeled with “RX” in the drawings) 236 for executing a conversion operation, a transmission operation and a reception operation respectively. In detail, when the detection result indicates that the memory card signal conforms to the first signal type, the converter 232 converts the memory card signal into a to-be-transmitted signal according to the conversion control signal; the transmitter 234 generates the card-to-system conversion signal according to the to-be-transmitted signal and outputs the card-to-system conversion signal to the system; furthermore, the receiver 236 outputs a to-be-converted signal to the converter 232 according to the system-side signal, and then the converter 232 converts the to-be-converted signal and thereby outputs a system-to-card conversion signal as a card-side output signal which is then outputted to the memory card. It should be noted that when the detection result indicates that the memory card signal conforms to the second signal type, which implies that the memory card and the system use the same signal transmission interface and the conversion operation has no need to be executed, the selection circuit 240 directly outputs the memory card signal to the system according to the selection control signal, and directly outputs the system-side signal to the memory card according to the selection control signal; in this case, the intermediate circuit 200 carries out the transmission and reception between the detection circuit 210 and the selection circuit 240 for the memory card signal and the system-side signal without a transmitter and a receiver, which can save the intermediate circuit 200 a set of transceiver. In should be also noted that if a signal has no need to be converted, the detection circuit 210 (or a bypass circuit or the equivalent thereof) may transmit the memory card signal to the selection circuit 240 directly, and transmit the system-side signal from the selection circuit 240 to the memory card directly.

In an embodiment, the first signal type is a parallel transmission signal type, and the second signal type is a SerDes signal type. In an embodiment, the memory card signal is a signal of Secure Digital (SD) card; the parallel transmission signal type conforms to one of the follows: the Default Speed (DS) transmission protocol of SD card, the High Speed (HS) transmission protocol of SD card, and the Ultra High Speed-I (UHS-I) transmission protocol of SD card; and the SerDes signal type conforms to the Ultra High Speed-II (UHS-II) transmission protocol of SD card.

The following description explains how the intermediate circuit 200 works for a system-to-card operation.

Please refer to FIG. 2c. The detection circuit 210 detects a memory card signal from the aforementioned memory card and thereby generates a detection result. The detection result indicates that the memory card signal conforms to one of a plurality of signal types. These signal types include a first signal type and a second signal type that are dedicated to a parallel interface and a SerDes interface respectively. The control circuit 220 generates a conversion control signal and a selection control signal according to the detection result. When the detection result indicates that the memory card signal conforms to the first signal type, the conversion circuit 230 converts a system-side signal into a system-to-card conversion signal as a card-side output signal according to the conversion control signal, in which the system-side signal comes from the aforementioned system and conforms to the second signal type while the system-to-card conversion signal conforms to the first signal type. Providing the detection result indicates that the memory card signal conforms to the first signal type, the selection circuit 240 receives the system-side signal and outputs the system-side signal to the conversion circuit 230 according to the selection control signal, so that the conversion circuit 230 generates the system-to-card conversion signal as the card-side output signal; providing the detection result indicates that the memory card signal conforms to the second signal type, the selection circuit 240 receives the system-side signal and outputs the system-side signal as the card-side output signal according to the selection control signal.

Since those of ordinary skill in the art can appreciate the detail and modification of the system-to-card operation by referring to the description of the card-to-system operation in the preceding paragraphs, which means that the features of the card-to-system operation can be applied to the system-to-card operation in a reasonable way, therefore repeated and redundant description is omitted without failing the written description and enablement requirements.

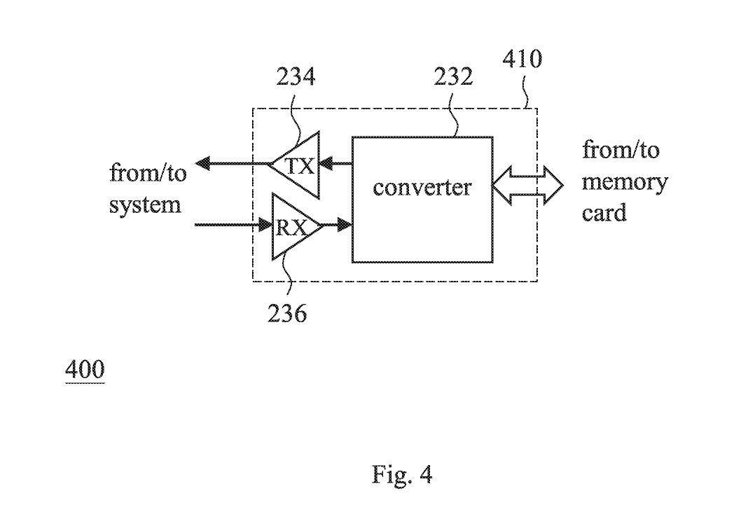

An embodiment of the intermediate circuit of the present invention only includes a conversion circuit that is used to cooperate with other circuit design. The said other circuit design could be a design having no detection circuit, control circuit and selection circuit, and being useful in a circumstance that the physical transmission interface between a memory card and the intermediate circuit is different from the physical transmission interface between a system and the intermediate circuit. In this circumstance, since the conversion circuit always executes a conversion operation, the aforementioned detection, control and selection operations are no longer necessary. As shown in FIG. 4, the intermediate circuit 400 in this embodiment includes a conversion circuit 410 configured to convert a memory card signal into a card-to-system conversion signal which is then outputted to a system, and configured to convert a system-side signal into a system-to-card conversion signal which is then outputted to a memory card. The said memory card signal conforms to a plurality of signal types, these signal types includes a first signal type and a second signal type, and the first signal type and the second signal type are dedicated to different physical transmission interfaces (e.g., a parallel interface and a SerDes interface) respectively. An embodiment of the conversion circuit 410 is the conversion circuit 230 of FIG. 3.

Since those of ordinary skill in the art can appreciate the detail and modification of the intermediate circuit 400 of FIG. 4 by referring to the disclosure of the intermediate circuit 200 in FIGS. 2a-2c and FIG. 3, which implies that the features of the intermediate circuit 200 can be applied to the intermediate circuit 400 in a reasonable way, therefore repeated and redundant description is omitted without failing the written description and enablement requirements.

To sum up, the intermediate circuit of the present invention can ensure the compatibility of memory card access without changing the existing circuit design of memory card access.

The aforementioned descriptions represent merely the exemplary embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An intermediate circuit for memory card access, the intermediate circuit comprising:
a detection circuit detecting a memory card signal to generate a detection result indicating the memory card signal conforming to one of a plurality of signal types, in which the plurality of signal types includes a first signal type and a second signal type that are dedicated to different physical transmission interfaces respectively;
a control circuit generating a conversion control signal and a selection control signal according to the detection result;
a conversion circuit converting the memory card signal into a card-to-system conversion signal of the second signal type according to the conversion control signal when the detection result indicates that the memory card signal conforms to the first signal type; and
a selection circuit receiving the card-to-system conversion signal and outputting the card-to-system conversion signal as a system-side output signal according to the selection control signal when the detection result indicates that the memory card signal conforms to the first signal type, and the selection circuit receiving the memory card signal and outputting the memory card signal as the system-side output signal according to the selection control signal when the detection result indicates that the memory card signal conforms to the second signal type.

2. The intermediate circuit of claim 1, wherein the memory card signal is a parallel transmission signal conforming to the first signal type, or the memory card signal is a Serializer/Deserializer (SerDes) signal conforming to the second signal type.

3. The intermediate circuit of claim 1, wherein the memory card signal is a signal of Secure Digital (SD) card.

4. The intermediate circuit of claim 1, wherein the second signal type conforms to an Ultra High Speed-II (UHS-II) transmission protocol of Secure Digital (SD) card, and the first signal type conforms to one of follows: a Default Speed (DS) transmission protocol of SD card; a High Speed (HS) transmission protocol of SD card; and an Ultra High Speed-I (UHS-I) transmission protocol of SD card.

5. The intermediate circuit of claim 1, wherein the conversion circuit includes:
a converter converting the memory card signal into a to-be-transmitted signal according to the conversion control signal when the detection result indicates that the memory card signal conforms to the first signal type; and
a transmitter generating and outputting the card-to-system conversion signal according to the to-be-transmitted signal when the detection result indicates that the memory card signal conforms to the first signal type.

6. The intermediate circuit of claim 5, wherein the conversion circuit further includes:
a receiver outputting a to-be-converted signal to the converter according to a system-side signal when the detection result indicates that the memory card signal conforms to the first signal type, in which the converter converts the to-be-converted signal and thereby outputs a system-to-card conversion signal as a card-side output signal.

7. An intermediate circuit for memory card access, the intermediate circuit comprising:
a detection circuit detecting a memory card signal to generate a detection result indicating the memory card signal conforming to one of a plurality of signal types, in which the plurality of signal types includes a first signal type and a second signal type that are dedicated to different physical transmission interfaces respectively;
a control circuit generating a conversion control signal and a selection control signal according to the detection result;
a conversion circuit converting a system-side signal into a system-to-card conversion signal as a card-side output signal according to the conversion control signal when the detection result indicates that the memory card signal conforms to the first signal type; and
a selection circuit receiving the system-side signal and outputting the system-side signal to the conversion circuit for generating the system-to-card conversion signal as the card-side output signal according to the selection control signal when the detection result indicates that the memory card signal conforms to the first signal type, and the selection circuit receiving the system-side signal and outputting the system-side signal as the card-side output signal according to the selection control signal when the detection result indicates that the memory card signal conforms to the second signal type.

8. The intermediate circuit of claim 7, wherein the memory card signal is a parallel transmission signal conforming to the first signal type, or the memory card signal is a Serializer/Deserializer (SerDes) signal conforming to the second signal type.

9. The intermediate circuit of claim 7, wherein the memory card signal is a signal of Secure Digital (SD) card.

10. The intermediate circuit of claim 7, wherein the second signal type conforms to an Ultra High Speed-II (UHS-Hl) transmission protocol of Secure Digital (SD) card, and the first signal type conforms to one of follows: a Default Speed (DS) transmission protocol of SD card; a High Speed (HS) transmission protocol of SD card; and an Ultra High Speed-I (UHS-I) transmission protocol of SD card.

11. The intermediate circuit of claim 7, wherein the conversion circuit includes:
a receiver outputting a to-be-converted signal to a converter according to the system-side signal when the detection result indicates that the memory card signal conforms to the first signal type; and
the converter converting the to-be-converted signal into the system-to-card conversion signal according to the conversion control signal when the detection result indicates that the memory card signal conforms to the first signal type.

12. The intermediate circuit of claim 11, wherein the converter further converts the memory card signal into a to-be-transmitted signal according to the conversion control signal when the detection result indicates that the memory card conforms to the first signal type, and the conversion circuit further includes:
a transmitter outputting a card-to-system conversion signal as a system-side output signal according to the to-be-transmitted signal when the detection result indicates that the memory card signal conforms to the first signal type.

13. An intermediate circuit for memory card access, the intermediate circuit comprising:
a conversion circuit configured to convert a memory card signal into a card-to-system conversion signal and output the card-to-system conversion signal to a system, and configured to convert a system-side signal into a system-to-card conversion signal and output the system-to-card conversion signal to a memory card,
wherein the memory card signal conforms to one of a plurality of signal types, the plurality of signal types includes a first signal type and a second signal type that are dedicated to different physical transmission interfaces respectively, and the system-side signal conforms to the second signal type.

14. The intermediate circuit of claim 13, wherein the system-side signal is a Serializer/Deserializer (SerDes) signal; the memory card signal is a parallel transmission signal conforming to the first signal type or the memory card signal is a SerDes signal conforming to the second signal type.

15. The intermediate circuit of claim 13, wherein the memory card signal is a signal of Secure Digital (SD) card.

16. The intermediate circuit of claim 13, wherein the second signal type conforms to an Ultra High Speed-II (UHS-TI) transmission protocol of Secure Digital (SD) card, and the first signal type conforms to one of follows: a Default Speed (DS) transmission protocol of SD card; a High Speed (HS) transmission protocol of SD card; and an Ultra High Speed-I (UHS-I) transmission protocol of SD card.

17. The intermediate circuit of claim 13, wherein the conversion circuit includes:
a converter configured to convert the memory card signal into a to-be-transmitted signal, and configured to convert a to-be-converted signal into the system-to-card conversion signal;
a transmitter configured to generate and output the card-to-system conversion signal according to the to-be-transmitted signal; and
a receiver configured to output the to-be-converted signal to the converter according to the system-side signal.
